(19) United States
(12) Patent Application Publication
(10) Pub. No.: US 2010/0155422 A1
(43) Pub. Date: Jun. 24, 2010

(54) Dye Pressing Device

(76) Inventor: Hyoun Myoung Shin, Kimpo City (KR)

Correspondence Address: IP STRATEGIES, 12 1/2 WALL STREET, SUITE E, ASHEVILLE, NC, 28801, US

(21) Appl. No.: 12/062,913

(22) Filed: Apr. 4, 2008

(30) Foreign Application Priority Data
Sep. 19, 2007 (KR) 20-2007-15634
Feb. 13, 2008 (KR) 20-2008-1887

(51) Int. Cl. B67D 7/74; B65D 83/14

(52) U.S. Cl. 222/135; 222/145.6; 222/373; 222/380

(57) ABSTRACT

The present invention provides a dye pressing device which improves the container composition of a dye pressing device used in the form of aerosols and the mix ratio of mixture released from the device.

Particularly, the present invention provides a dye pressing device comprising the containers of the dye pressing device used in the form of aerosols separately for the accommodation of the medicine and the oxidizing agent; the medicine container and the oxidizing agent container enable to release an equal amount of medicine and oxidizing agent respectively in equal time by the high pressure gas contained therein; a mix pail where the medicine released from the medicine container and the oxidizing agent released from the oxidizing agent container mix together for the first time; and coupled screws installed inside of the mix pail which processes a mix one more time for a high quality mix.

### FIELD OF THE INVENTION

The present invention provides a dye pressing device, wherein a dye container and an oxidizing agent container for dyeing in the form of aerosol are formed integrally in a container.

The present invention comprises coupled screws to be inserted into, and installed in, a pail for mixing dyeing medicine and oxidizing agent for a high quality mix.

A partition is formed in the center of the container according to the present invention so that the medicine and the oxidizing agent may be accommodated separately.

### BACKGROUND OF THE INVENTION

A conventional dye container forms a medicine container and an oxidizing agent container separately. For the use of dyeing medicine, the medicine container and the oxidizing agent container are fixed by a bracket and a support, the nozzles of containers are pressed to release the medicine and oxidizing agent in a required ratio for a mix, and the mixture passes through a brush during the mixing process.

Two containers may be attached to be fixed externally for an integral use, in which case an equal height can be hardly maintained. And extra time and cost are consumed for the work.

Although the containers are fixed by the bracket, because the containers are not integral, repeated presses of nozzles may change the height of container, in which case the amount of release from the nozzles changes, causing a different mix ratio of medicine and oxidizing agent.

Also, because the mix ratio of the medicine and the oxidizing agent is more likely different from time to time, if the amount of medicine gets less than that of oxidizing agent, the dyebility decreases and, if the amount of oxidizing agent gets more that that of medicine, the hair damage occurs.

The separate formation of the medicine container and the oxidizing agent container can hardly guarantee a best quality dyeing.

### SUMMARY OF THE INVENTION

The present invention provides a dye pressing device, where-in a medicine container and an oxidizing agent container are formed integrally in a container.

The present invention provides a container with a sealed partition formed lengthwise in the center of the container.

The present invention is characteristic of the composition comprising coupled screws to be inserted into, and installed in, a mix pail for extra mixing process in order to mix in good quality the medicine and the oxidizing agent which flow into the mix pail through the nozzles of container.

The container of the present invention is made by plastic injection molding.

A partition is formed lengthwise in the center of the container according to the present invention, and the medicine container and the oxidizing agent container are formed integrally in both sides of the partition.

Screws are inserted into the mix pail, and grooves with various pitches are formed on the outside of the screws.

A hole of a required size is made lengthwise in the center of the above screw and a screw is inserted into the hole to be fixed.

Because the inlets of both the medicine container and the oxidizing agent container are of a height due to the fact that the medicine container and the oxidizing agent container with a partition formed in the center constitute a body together, and because the height of nozzles is same, a press on the button applies the same power to the nozzles to release the same amount of medicine and oxidizing agent, thereby formulating a desirable mix ratio;
because the medicine and the oxidizing agent pass through the pair of screws installed inside the mix pail, the medicine and the oxidizing agent are able to be mixed in good quality;
because the uniform height of container inlet keeps a constant discharge pressure, leak is prevented, reducing the loss rate and the cost;
the cubage reduced by the integral composition enhances user convenience and the market quality of product as well; and
because the work for filling the medicine and the oxidizing agent in the corresponding containers and sealing each containers is done in the same place, the working time can be shortened.

### BRIEF DESCRIPTION OF THE DRAWINGS

FIG. 1 illustrates an overall view of the dye pressing device according to the present invention.

FIG. 2 illustrates a separational view of the dye pressing device according to the present invention.

FIG. 3 illustrates a cross sectional view taken along line A*A′ of FIG. 1.

FIG. 4 is a detail drawing of the mix pail.

FIG. 5 is a drawing that shows the assembled state of bracket and container.

FIG. 6 is a drawing that shows the mix pail in a horizontal state

FIG. 7 is a drawing that shows the relationship between the mix pail and the presser.

FIG. 8 is a detail drawing of the screws.

L Description of the Major Parts of the Drawings L

```
  1: Container
  2: Brush
  3: Bracket
  4: mix pail
  5: Screw (a, b)
  6: Moving Course
  7: outlet pipe
  8: Button
  9: Presser
10: Guide (a, b)
11: Joint (a, b)
12: Support
13: Medicine Container
14: Oxidizing Agent Container
15: Inlet
16: Partition
17: Space
18:
19:
20:
21: Nozzle
22: Cap
23: Hole
24: Groove
```

### DETAILED DESCRIPTION OF THE PREFERRED EMBODIMENT

The present invention provides a dye container (1) in the center of which a partition (16) is formed lengthwise so that the medicine container (13) and the oxidizing agent container (14) may be formed to accommodate the medicine and the oxidizing agent separately.

The present invention provides a container (1) the cubage of which is reduced by the integral formation of the medicine container (13) and the oxidizing agent container (14).

The present invention comprises a mix pail (4) making a good mix of medicine and oxidizing agent.

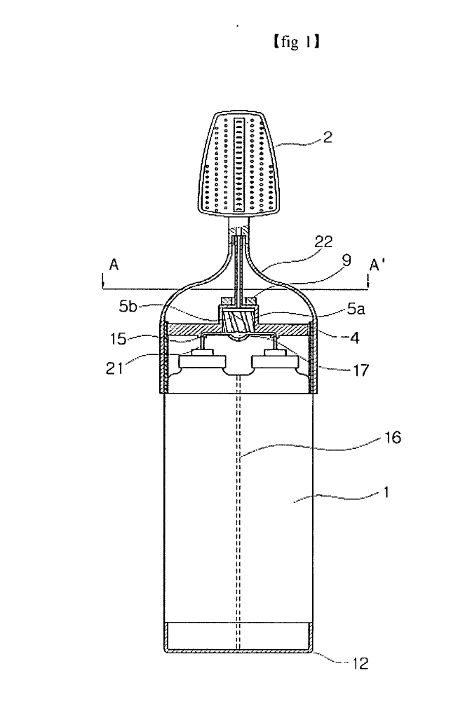

FIG. 1 illustrates a composition of the dye pressing device according to the present invention.

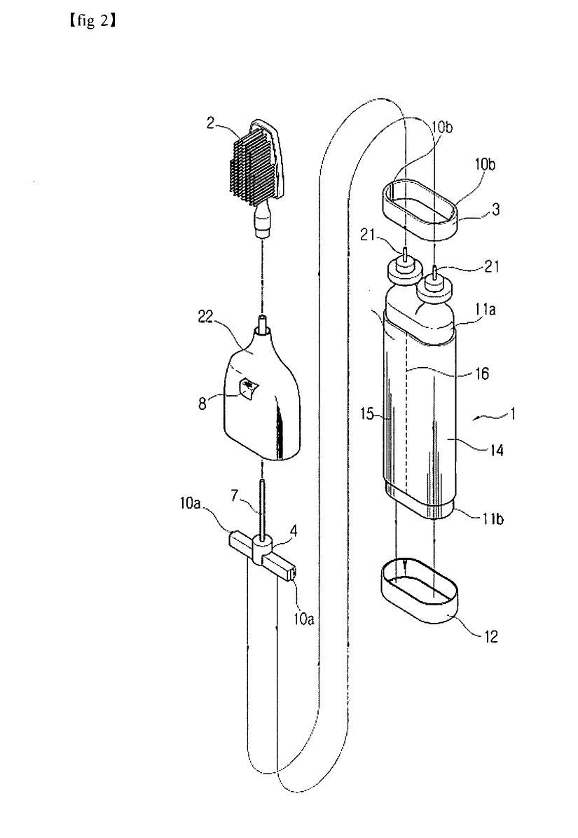

FIG. 2 illustrates a separate composition of the dye pressing device according to the present invention.

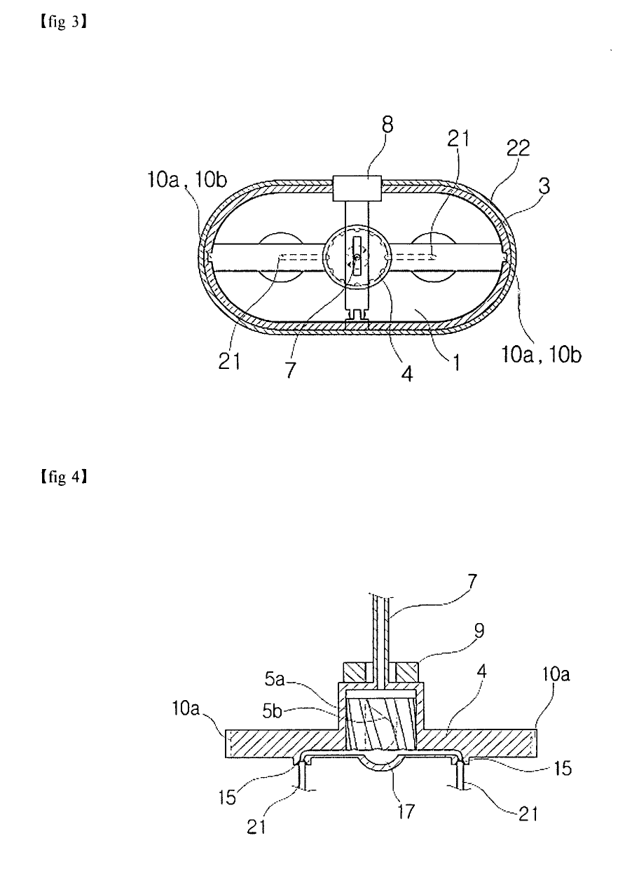

FIG. 3 illustrates an assembled relationship between the nozzles of container and the presser for pressing the mix pail and the nozzles.

FIG. 4 illustrates an operational state according to the composition of mix pail.

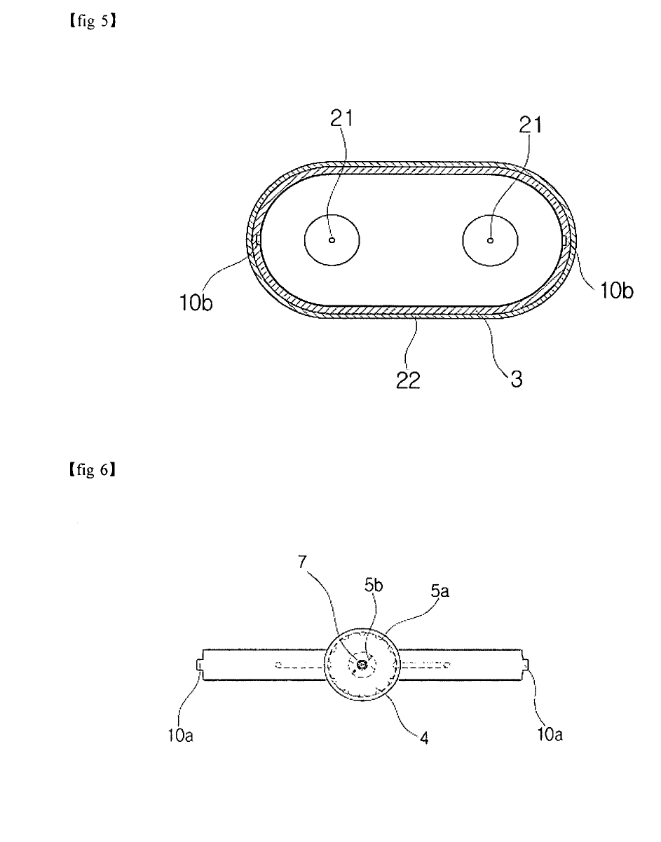

FIG. 5 illustrates an assembled and fixed state of the container and the bracket for supporting the mix pail.

FIG. 6 illustrates the mix pail in a horizontal state.

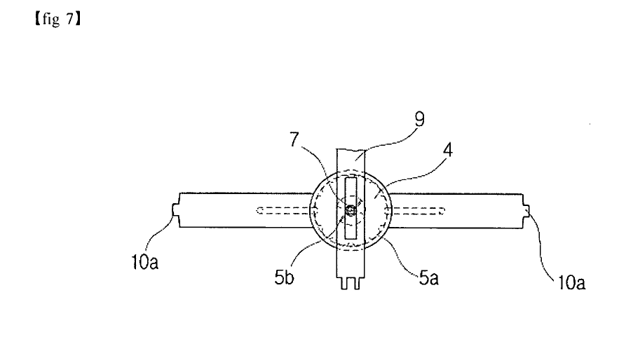

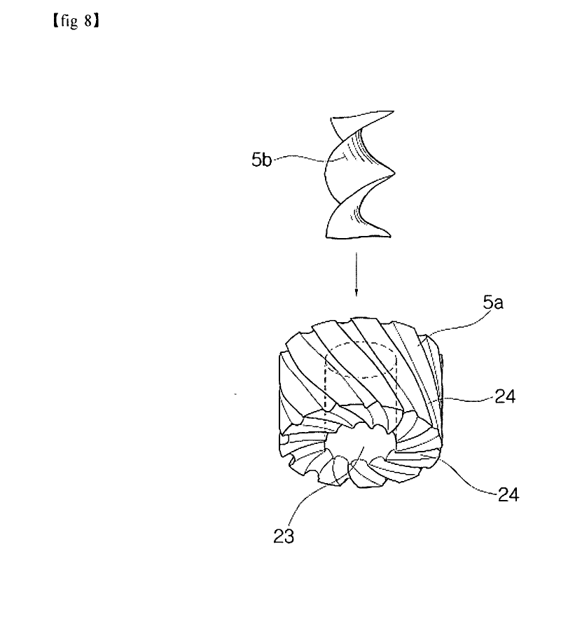

FIG. 7 illustrates the relationship between the mix pail and the presser with the operation.

FIG. 8 illustrates the detail state of screws contained in the mix pail.

A partition (16) is formed lengthwise in the center of container (1).

As shown in FIG. 2, nozzles (21) are installed and fixed onto the two inlets in the upper part of the container (1).

As shown in FIG. 2, a joint (11b) is formed in the lower part of the container (1) and a joint (11a) is formed in the upper part of the container (1) and the joints are formed inward at a required distance from the outer circumference of container so that, when the bracket (3) and the support (12) are assembled with the container (1), the outer circumferential sides of the container (1), the bracket (3) and the support (12) may surface.

A guide (10b) of the bracket (3) is formed in the inner wall, and to the height of, the bracket (3), and the guide (10b) and the guide (10a) of mix pail (4) join together to support the mix pail (4).

As shown in FIG. 3, the guide (10a) of mix pail (4) is formed to slip into, and join, the guide (10b) of the bracket (3) so that the mix pail (4) housed by the bracket (3) may move up and down easily.

As shown in FIG. 4, two inlets (15) are formed under the bottom of mix pail (4).

A moving course (6) of medicine and the oxidizing agent is formed to link up with the inlets (15).

Following the moving course (6), a mixing space (17) is formed in the center of the mix pail (4), as shown in FIG. 1, and, above the space (17) a cylinder-shaped screw (5a) may be contained and revolve. In the outer circumferential surface are formed lengthwise a plurality of grooves (24) like the thread of a screw.

A hole (23) of a required size is made in the center of the above screw (5a).

A screw (5b) is inserted into the above hole (23) closely, as shown in FIG. 8.

In the bottom of screw (5a) above, the grooves (24), which are shaped like the thread of a screw and formed on the outer circumferential surface of the screw (5a) and to the lengthwise direction of the screw (5a), are formed to extend to the entrance of hole (23).

An outlet pipe (7) protrudes from the top center of the mix pail (4).

On the top of mix pail (4) is formed an easily pressable presser (9) which accommodates the outlet pipe (7) above and one end of which is hinged onto the inside of the cap (22) and the other end of which is located just under the button (8). The button (8) above is formed so that a press may move the mix pail (4) up and down easily.

The cap (22) with a brush (2) affixed on is formed to surround the outside of bracket (3).

The nozzles (21) are formed to be exposed after the medicine and the oxidizing agent are filled in the medicine container and the oxidizing agent container respectively and the tap is sealed.

The bracket (3) is assembled with, and fixed to, the joint (11a) in the upper part of the container (1).

As shown in FIG. 3, the mix pail (4) is assembled with the bracket (3) so that the bracket (3) may surround the mix pail (4).

The guides (10a) formed on both sides of the mix pail (4) are formed to slip into the guides (10b) formed on the inside of bracket (3).

When the mix pail (4) and the bracket (3) are assembled in the manner described above, the nozzles (21) of container (1) join with the inlets (15) protruded from the bottom of the mix pail (4).

The brush (2) is affixed on the top of cap (22).

When the bracket (3) is covered by the cap (22), the lower part of the cap (22) accommodates the outer circumference of bracket (3), and the cap (22) is fixed to the bracket (3) by a clip (not illustrated).

One side of the presser (9) is hinged inside of the cap (22) and a hole (not illustrated) is formed in the center of the presser (9). When the bracket (3) is covered by the cap (22), the outlet pipe (7) of mix pail (4) passes through the presser (9), and the exposed outlet pipe (7) on the presser (9) joins with the brush (2).

The composition described above comprises the support (12) installed in the lower part of the container (1), the bracket (3) installed and fixed to accommodate the nozzles (21) in the upper part of the container (10), and the cap (22) on top of the bracket (3).

When the cap (22) is put on top of the bracket (3), the button (8) is positioned on the presser (9) to press the presser (9).

Under the condition that the container (1) is filled with the medicine and the oxidizing agent; the tap is sealed and the nozzles (21) are formed; the bracket (3) is assembled with, and fixed to, the joint (11a) in the upper part of the container (1); the mix pail (4) is assembled with the bracket (3) so that the bracket (3) may surround the mix pail (4); the inlets (15) of mix pail (4) join with the nozzles (21); the cap (22) is put on top of the bracket (3) to be installed and fixed to the bracket (3); and the presser (9) is positioned on mix pail (3) and the button (8) is positioned on the presser (9), a press on the button (8) presses the presser (9), and the presser (9) presses the mix pail (4).

The pressed mix pail (4) moves down, pressing the nozzles (8).

A press of the nozzles (8) releases the medicine of medicine container and the oxidizing agent of oxidizing agent container of the container (1).

The blown-up medicine and oxidizing agent pass through the nozzles (8), then the inlets (15), then the moving course (6), and are mixed in the mix space (17) of the mix pail (4). The mixture moves up above the mix pail (4).

A plurality of grooves (24) shaped like the thread of a screw being formed on the outer circumferential surface of mix pail (4) and extended to the hole (23) of the screw (5a) on the bottom of mix pail (4), and the screw (5b) being formed in the hole (23) as well, the mixture that passes through the mix pail (4), on the one hand, moves along the grooves (24) on the outer circumferential surface and goes out through the outlet pipe (7) and, on the other hand, moves along the grooves extended to the hole (23) of the screw (5a) on the bottom of mix pail (4), and passes through the hole (23) with the screw (5b) fixed inside, thereby lifting up the screw (5a) and expanding the mix space (17) of mix pail (4) where the medicine and the oxidizing agent are mixed. Therefore, the mix work and the movement of mixture can be accomplished promptly. The mixture so promptly mixed in good quality passes through the outlet pipe (7) to the brush (2).

What is claimed is:

1. A dye pressing device characteristic of the composition comprising:
a container (1) with a medicine container (13) and an oxidizing agent container (14) formed integrally by injection molding;
a space (17) where medicine and oxidizing agent are mixed in good quality; and
a mix pail (4) which contains a screw (5a) for a desirable mix of medicine and oxidizing agent.

2. The device as claimed in claim 1, wherein the screw (5a) is characteristic of a plurality of grooves (24) like the thread of a screw and formed in a lengthwise direction on the outer circumferential surface of screw (5a).

3. The device as claimed in claim 1, wherein the screw (5a) comprises:
a hole (23) made in the center of the screw (5a);
a screw (5b) fixed lengthwise in the hole (23); and
a plurality of grooves (24) extended toward the entrance of hole (23) on the bottom of screw (5a) for an easier inflow of the mixture.
